(19) United States
(12) Patent Application Publication
(10) Pub. No.: US 2012/0213272 A1
(43) Pub. Date: Aug. 23, 2012

(54) METHOD AND SYSTEM FOR ADJUSTING VIDEO AND AUDIO QUALITY OF VIDEO STREAM

(75) Inventors: Chih-Chien LIU, Taipei City (TW); Shao-Tsu KUNG, Taipei City (TW); Yi-Chang CHEN, Taipei City (TW)

(73) Assignee: COMPAL ELECTRONICS, INC., Taipei City (TW)

(21) Appl. No.: 13/401,861

(22) Filed: Feb. 22, 2012

Related U.S. Application Data
(60) Provisional application No. 61/445,522, filed on Feb. 22, 2011.

(51) Int. Cl. H04N 7/26

(52) U.S. Cl. 375/240.02; 375/E07.126

(57) ABSTRACT

In a method for adjusting video or audio quality of a video stream, a video stream request for requesting an original target video stream from a client is received. Then, information about a connection bandwidth of the client is obtained, and a step is performed for determining if the connection bandwidth of the client is sufficient for receiving the target video stream. When it is determined that the connection bandwidth of the client is insufficient, at least one video or audio parameter is selected according to the information about the connection bandwidth of the client to adjust and reduce the video or audio quality of the target video stream, and the quality-reduced target video stream is transmitted to the client. Information about connection bandwidth of the client is continually obtained for transmitting all of the target video stream to the client.

### BACKGROUND

1. Technical Field

The present invention relates to a method and a system for adjusting video or audio quality of a video stream.

2. Description of Related Art

Recently, there are more and more web sites for sharing albums or streams over a network. Furthermore, many multimedia formats have been developed, such that high quality video can be shared through a network. Users also tend to watch high quality videos.

Higher-quality videos require larger data size, and, as a result, larger bandwidth is required to transmit the higher-quality videos. Hence, if clients want to watch high-quality videos through the network, large bandwidth may be needed. In other words, if there is no sufficient bandwidth to receive the high-quality videos, client devices cannot play the received high-quality videos smoothly. Hence, users often have poor experience for watching videos through the network.

### SUMMARY

According to one embodiment of this invention, a method for adjusting video or audio quality of a video stream is provided to reduce video or audio quality of a video stream when a connection bandwidth of a client is not sufficient, and to transmit the quality-reduced video stream to the client. The method for adjusting video or audio quality of a video stream may take the form of a computer program product stored on a computer-readable storage medium having computer-readable instructions embodied in the medium. Subsequently, a computer can perform the method for adjusting video or audio quality of a video stream after reading the computer-readable storage medium thereof. The method for adjusting video or audio quality of a video stream includes the following steps:

(a) receiving a video stream request for requesting an original target video stream from a client;

(b) obtaining information about a connection bandwidth of the client;

(c) determining if the connection bandwidth of the client is sufficient for receiving the target video stream; when it is determined that the connection bandwidth of the client is sufficient, directly transmitting the bandwidth-fitting target video stream, or enhancing the target video stream of which the quality has been reduced to obtain a quality-enhanced target video stream ; and then transmitting the quality-enhanced target video stream;

(d) when it is determined that the connection bandwidth of the client is insufficient, selecting at least one video or audio parameter according to the information about the connection bandwidth of the client so as to adjust and reduce the video or audio quality of the target video stream to obtain a quality-reduced target video stream, and transmitting the quality-reduced target video stream to the client.

(e) repetitively performing step (b), step (c) and step (d) to transmit the whole target video stream to the client.

According to another embodiment of this invention, a system for adjusting video or audio quality of a video stream is provided to reduce video or audio quality of a video stream when a connection bandwidth of a client is not sufficient, and to transmit the quality-reduced video stream to the client. The system for adjusting video or audio quality of a video stream includes a communication module and a processing unit which are electrically connected to each other. The communication module is used to build a connection with a client. The processing unit includes a request receiving module, a stream obtaining module, a bandwidth information obtaining module, a bandwidth determining module and a quality adjusting module. The request receiving module is used to receive a video stream request for requesting a target video stream from a client through the communication module. The stream obtaining module is used to obtain the target video stream. The bandwidth information obtaining module is used to obtain information about a connection bandwidth of the client. The bandwidth determining module is used to determine if the connection bandwidth of the client is sufficient for receiving the target video stream. The quality adjusting module is used to select at least one video or audio parameter according to the information about the connection bandwidth of the client so as to adjust and reduce the video or audio quality of the target video stream to obtain a quality-reduced target video stream, in which the quality adjusting module transmits the quality-reduced target video stream to the client when it is determined that the connection bandwidth of the client is insufficient. The quality adjusting module transmits the quality-reduced target video stream to the client through the communication module. The bandwidth information obtaining module and the bandwidth determining module are continually operated to transmit the whole target video stream to the client.

The present invention can achieve many advantages. When the connection bandwidth of the client is insufficient, the bandwidth for the target video stream can be reduced by reducing the video or audio quality of the target video stream, thereby preventing the target video stream from being played unsmoothly when the bandwidth is insufficient.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow chart showing a method for adjusting video or audio quality of a video stream according to one embodiment of this invention;

FIG. 2 illustrates a block diagram showing a system for adjusting video or audio quality of a video stream according to an embodiment of this invention; and

FIG. 3 is an embodiment of the processing unit 320 in FIG. 2.

### DETAILED DESCRIPTION

Reference will now be made in detail to the present embodiments of the invention, examples of which are illustrated in the accompanying drawings.

Wherever possible, the same reference numbers are used in the drawings and the description to refer to the same or like parts.

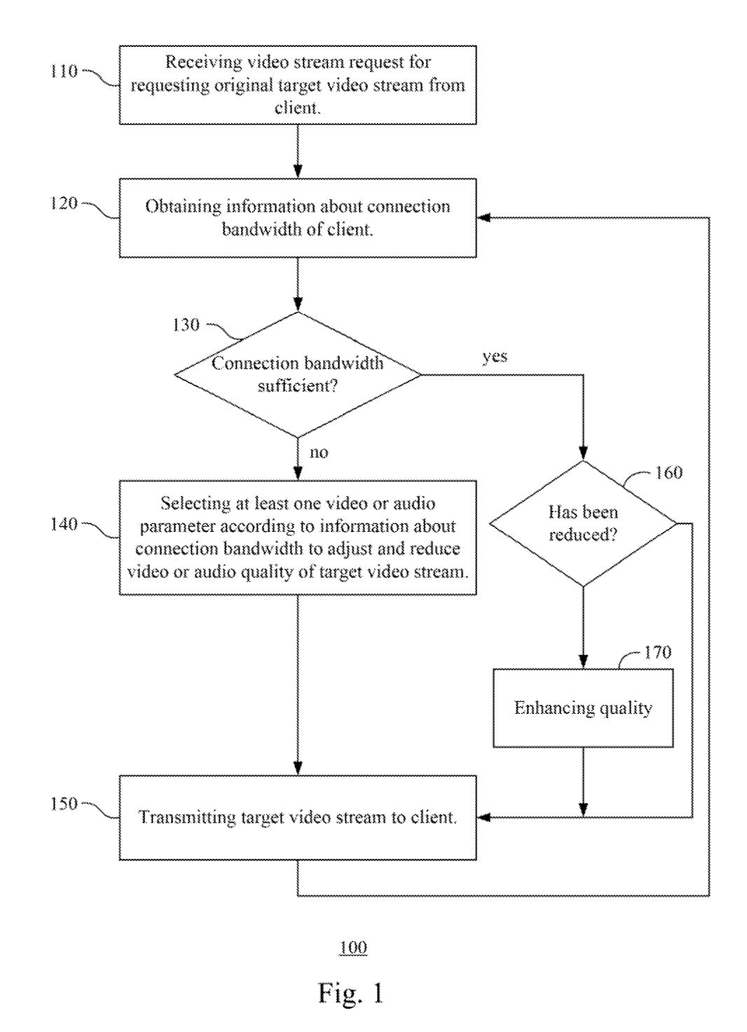

Referring to FIG. 1, FIG. 1 is a flow chart showing a method for adjusting video or audio quality of a video stream according to one embodiment of this invention. In the method for adjusting video or audio quality of a video stream, video or audio quality of a video stream is reduced when a connection bandwidth of a client is not sufficient, and the quality-reduced video stream is transmitted to the client. The method for adjusting video or audio quality of a video stream may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

The method for adjusting video or audio quality of a video stream 100 includes the following steps:

At step 110, a video stream request for requesting an original target video stream is received from a client.

At step 120, information about a connection bandwidth of the client is obtained. In one embodiment, the connection bandwidth of the client may be estimated in accordance with a number of packets downloaded by the client in a predetermined period. In another embodiment, the connection bandwidth of the client may be estimated in accordance with a number of packets received from the client. In other embodiments of this invention, other methods may be utilized to obtain the information about the connection bandwidth of the client, but this invention is not limited thereto.

Step 130 is performed to determine if the connection bandwidth of the client is sufficient for receiving the target video stream. For example, the determination at step 130 may be made by determining if the connection bandwidth of the client is greater than a connection bandwidth threshold.

When it is determined that the connection bandwidth of the client is sufficient, step 150 may be performed to transmit the target video stream to the client. In one embodiment of this invention, when the connection bandwidth of the client is determined to be sufficient, step 160 may be performed to determine if the video or audio quality of the target video stream has been reduced. When the video or audio quality of the target video stream has been reduced, at least one video or audio parameter is selected according to the information about the connection bandwidth of the client to adjust and enhanced the video or audio quality of the target video stream to fit the connection bandwidth of the client for being transmitted at step 150. When the video or audio quality of the target video stream has not been reduced, the original target video stream without quality adjustment is directly transmitted at step 150. Therefore, the target video stream with better quality can be provided to the client.

At step 140, when it is determined that the connection bandwidth of the client is insufficient, at least one video or audio parameter is selected according to the information about the connection bandwidth of the client so as to adjust and reduce the video or audio quality of the target video stream to obtain a quality-reduced target video stream. The at least one video or audio parameter may be a color depth parameter, a resolution parameter, a chrominance value, a chroma value, the number of frames which are able to utilize same color data, an audio sampling rate, any other video or audio parameter, or one or more parameters selected thereof. When the at least one video or audio parameter of the target video stream is the color depth parameter, the color depth parameter can be reduced in an order of true color →32 bits÷16 bits→256 colors. Furthermore, in one embodiment, the target video stream can be encoded according to the selected video or audio parameter so as to reduce the video or audio quality of the target video stream. Moreover, the quality-reduced target video stream may be temporarily stored for being obtained by other clients subsequently without needing to repeat the conversion on the same target video stream.

Hence, at step 150, the quality-reduced target video stream is transmitted to the client. Subsequently, step 120 to step 150 are continually performed to continually obtain the connection bandwidth of the client as the base to reduce the video or audio quality of the target video stream or not. Therefore, when the connection bandwidth of the client is insufficient, the bandwidth for the target video stream can be reduced by reducing the video or audio quality of the target video stream, thus preventing the target video stream from being played unsmoothly when the bandwidth is insufficient. Moreover, step 120 to step 150 can be performed continually to select the at least one video or audio parameter round by round so as to reduce the quality of the target video stream gradually. Besides, an adjusted video stream may be received, and a next video or audio adjustment parameter may be set through a user interface according to the quality of the adjusted video stream, thereby performing adjustment of reducing the quality of the adjusted video stream. In other words, users can set a priority sequence of selecting the video or audio parameters (or called a quality reduced selecting priority sequence of the video or audio parameters) for gradually reducing the quality of the target video stream through a user interface. In addition, a user can also preset the priority sequence of selecting the video or audio parameter among several parameters.

In one embodiment of this invention, the video or audio parameter for reducing quality may be a color depth parameter or a resolution parameter of the target video stream. Hence, the method for adjusting video or audio quality of a video stream 100 may further include the step of determining if the color depth parameter of the target video stream has been reduced to a minimum color depth value, and the step of determining if the resolution parameter of the target video stream has been reduced to a minimum resolution value. For example, the minimum color depth value may be preset to 4 bits, and the resolution parameter may be preset to 1/8 of the original resolution. In one embodiment of step 140, the color depth parameter of the target video stream can be reduced gradually. When the color depth parameter of the target video stream is reduced to the minimum color depth value, the resolution parameter of the target video stream is then gradually reduced. In another embodiment, the resolution parameter of the target video stream can be reduced gradually. When the resolution parameter of the target video stream is reduced to the minimum resolution value, the color depth parameter of the target video stream is then gradually reduced. When the color depth parameter of the target video stream has been reduced to the minimum color depth value and the resolution parameter of the target video stream has been reduced to the minimum resolution value but the connection bandwidth of the client is still insufficient, the target video stream may be converted into a black-and-white video stream at step 140 to further reduce the video or audio quality of the target video stream. In another embodiment, when the connection bandwidth of the client is smaller than a minimum threshold (for example, 1.2 Mbps), the target video stream may be converted into a black-and-white video stream. Subsequently, the black-and-white video stream is transmitted to the client, such that the transmission bandwidth can be further reduced. Therefore, the black-and-white video stream is transmitted only when the color depth parameter and the resolution parameter are both set to minimum values. In other words, the target video stream may not be converted to the black-and-white video stream which is considered as poor quality, when there are still other video or audio parameters available for adjustment.

In another embodiment of this invention, the at least one video or audio parameter of the target video stream is a chrominance value or a chroma value of the target video stream, and the target video stream includes at least one reference frame and at least one inter frame which is predicted in accordance with the reference frame. Hence, in one embodiment of step 140, the reference frame and the at least one inter frame may be set to the same chrominance value or the same chroma value to reduce video or audio quality of the target video stream.

In another embodiment of this invention, the current setting of the video and audio parameter for transmitting the target video stream can be obtained in advance. Hence, in one embodiment of step 140, a strategy to adjust at least one video or audio parameter can be selected by looking-up an adjustment strategy table corresponding to the current setting according to the information of the connection bandwidth of the client. The video or audio parameter for adjustment may include a color depth parameter, a resolution parameter, a chrominance value, a chroma value, number of frames able to utilize the same color data, audio sampling rate, any other video or audio parameter, or one or more parameters selected from thereof. Several different video or audio parameter can be utilized for adjustments under different bandwidth. Users or providers can preset the priority to utilize which parameter to adjust the target video stream, or a user interface may be provided to users for dynamically setting. In other words, users can set their own adjustment strategy table. For instance, when the current setting is 1080 p 24 frames, different adjustment strategies may be utilized under different transmission bandwidth. In one embodiments, when the connection bandwidth of the client is 3.5 Mbps, which represents that the client is under a high quality of connection bandwidth, the setting of the video or audio parameters of the target video stream may remain the same. When it is detected that the connection bandwidth of the client is 3.2 Mbps-2.5 Mbps, the quality reduction of the target video stream can be performed by adjusting the color depth parameter, the resolution parameter, the chrominance value, etc. If a user sets “the color depth parameter” as the first option under such connection bandwidth, the color depth parameter of the video and audio parameter can be reduced to 6 bits-4 bits, and determining if the connection bandwidth of the client may be performed continually; when it is detected that the connection bandwidth of the client is 1.8 Mbps-1.3 Mbps, the quality reduction of the target video stream can be performed by adjusting the color depth parameter, the resolution parameter, the chroma value etc. If a user sets “the resolution parameter” as the first option under such connection bandwidth, the resolution of target video stream can be reduced to ½-⅛ of the original resolution, and determining if the connection bandwidth of the client may be performed continually; when it is detected that the connection bandwidth of the client is very few (for example, 1.2 Mbps-0.3 Mbps), the quality reduction of the target video stream can be performed by setting several frames to the same color data. Accordingly, the minimum color depth value can be preset to 4 bits, the minimum resolution value can be preset to ⅛, the maximum number of frames able to utilize the same color data can be preset to 20 frames. In this embodiment, when the connection bandwidth of the client is high, the current setting of the video and audio parameter of the target video stream for transmission may not be changed. When the connection bandwidth of the client is a little bit low, the color depth of the target video stream can be adjusted. When the connection bandwidth of the client is extremely low, the reference frame and a predetermined number of inter frames which are predicted in accordance with the reference frame, are set to the same chrominance value or chroma value. In other embodiments of this invention, different adjustment strategy tables can be designed in accordance with requirements and used as the base for adjusting the video and audio parameter of the target video stream, but this invention is not limited thereto.

In another embodiment of this invention, the at least one video or audio parameter of the target video stream includes an audio sampling rate of the target video stream. Hence, in one embodiment of step 140, the audio sampling rate of the target video stream may be reduced to reduce the video or audio quality of the target video stream. For example, such reduction can be performed by reducing audio frequency or bit rate.

Furthermore, the method for adjusting video or audio quality of a video stream 100 may further include the step of adjusting the at least one video or audio parameter of the target video stream to enhance the video or audio quality of the target video stream. Therefore, when the connection bandwidth is sufficient, the target video stream can be provided with better quality to give users of the client better watching experience.

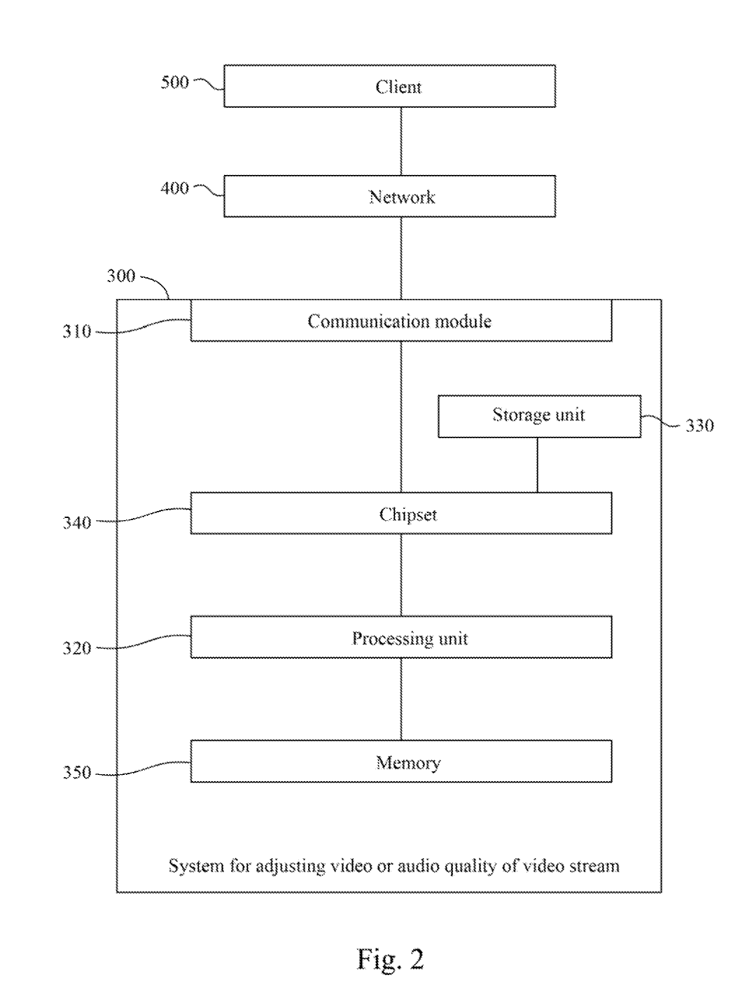

FIG. 2 illustrates a block diagram showing a system for adjusting video or audio quality of a video stream according to an embodiment of this invention. The system reduces video or audio quality of a video stream when a connection bandwidth of a client is not sufficient, and transmits the quality-reduced video stream to the client.

The system 300 for adjusting video or audio quality of a video stream includes a communication module 310 and a processing unit 320. The communication module 310 is electrically connected to the processing unit 320 through a chipset 340. In one embodiment of this invention, the system 300 for adjusting video or audio quality of a video stream can be implemented by a single computer or server. In another embodiment of this invention, several computers or servers can be utilized to implement the system 300 for adjusting video or audio quality of a video stream.

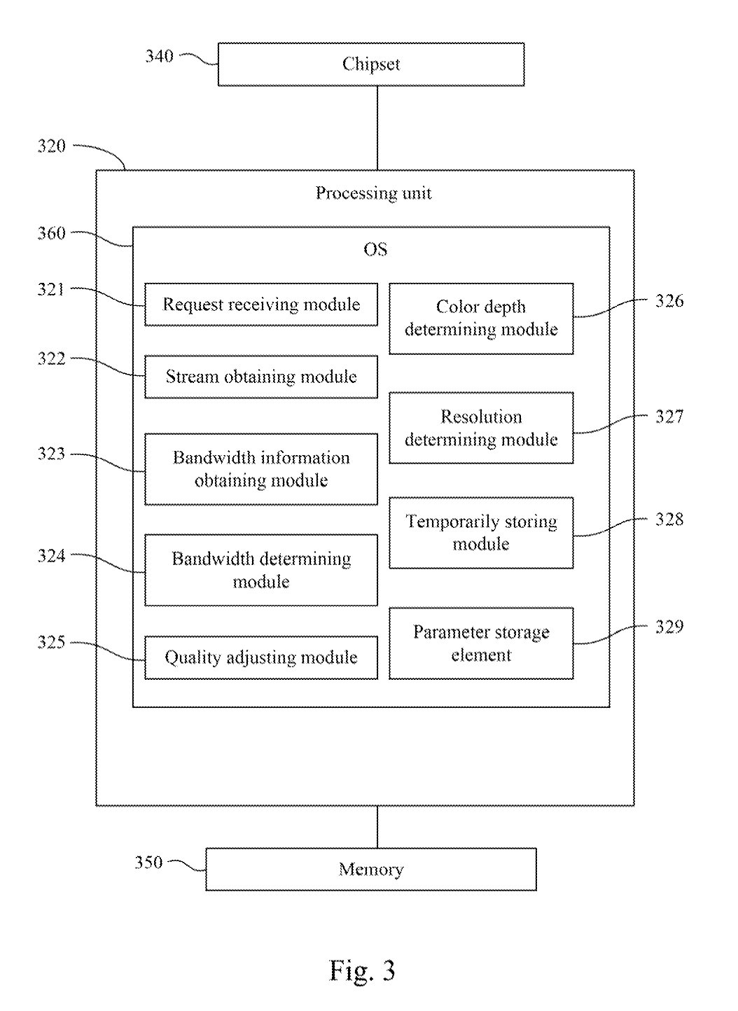

The communication module 310 builds a connection with a network 400 for building a connection with the client 500. FIG. 3 is an embodiment of the processing unit 320 in FIG. 2. Referring to FIG. 2 and FIG. 3, the processing unit 320 includes a request receiving module 321, a stream obtaining module 322, a bandwidth information obtaining module 323, a bandwidth determining module 324 and a quality adjusting module 325. Wherein, the processing unit 320 may read program codes corresponding to modules 321-325 from the storage unit 340 through the chipset 340 and temporarily store the program codes into a memory 350. Hence, the processing unit 320 can read the program codes of the modules 321-325 to perform functions of the modules 321-325 under an operating system (OS) 360. In one embodiment of this invention, the request receiving module 321, the stream obtaining module 322, the bandwidth information obtaining module 323, the bandwidth determining module 324 and the quality adjusting module 325 can be implemented in a single processing unit. In another embodiment of this invention, the stream obtaining module 322, the bandwidth information obtaining module 323, the bandwidth determining module 324 and the quality adjusting module 325 can be implemented discretely in processing units of several computers or servers.

The request receiving module 321 receives a video stream request for requesting a target video stream from a client 500 through the communication module 310. The stream obtaining module 322 obtains the target video stream. The bandwidth information obtaining module 323 obtains information about a connection bandwidth of the client 500. In one embodiment of this invention, the bandwidth information obtaining module 323 may obtain a number of packets downloaded by the client 500 in a predetermined period, and estimate the connection bandwidth of the client 500 through the network 400. In another embodiment of this invention, the bandwidth information obtaining module 323 may estimate the connection bandwidth of the client according to a number of packets received from the client 500 through the network 400. In other embodiments of this invention, the bandwidth information obtaining module 323 may utilize other methods to obtain the information about the connection bandwidth of the client 500, but this invention is not limited thereto.

The bandwidth determining module 324 determines if the connection bandwidth of the client 500 is sufficient for receiving the target video stream. When it is determined that the connection bandwidth of the client is insufficient, the quality adjusting module 325 selects at least one video or audio parameter according to the information about the connection bandwidth of the client 500 so as to adjust and reduce the video or audio quality of the target video stream to obtain a quality-reduced target video stream. The at least one video or audio parameter may be a color depth parameter, a resolution parameter, a chrominance value, a chroma value, the number of frames which are able to utilize same color data, an audio sampling rate, any other video or audio parameter, or one or more parameters selected thereof. In one embodiment of this invention, the quality adjusting module 325 may encode the target video stream according to the reduced video or audio parameter to reduce the video or audio quality of the target video stream. In addition, a temporarily storing module 328 of the processing unit 320 may temporarily store the quality-reduced target video stream into a storage unit 330 for being obtained by other clients subsequently without needing to repeat the conversion on the same target video stream. In one embodiment, the processing unit 320 is electrically connected to the storage unit 330. Furthermore, the processing unit 320 may store the adjusted video or audio parameter of the target video stream into a parameter storage element 329 for latter adjustment.

Subsequently, the quality adjusting module 325 drives the communication module 310 to transmit the quality-reduced target video stream to the client 500 through the network. In addition, the bandwidth information obtaining module 323 and the bandwidth determining module 324 are continually operated to transmit all of the target video stream to the client. Therefore, when the connection bandwidth of the client 500 is insufficient, the bandwidth for the target video stream can be reduced by reducing the video or audio quality of the target video stream, thereby preventing the client 500 from playing the target video stream unsmoothly when the bandwidth is insufficient. Moreover, the bandwidth information obtaining module 323 and the bandwidth determining module 324 are continually operated to select the at least one video or audio parameter round by round so as to reduce the quality of the target video stream gradually.

In one embodiment of this invention, the video or audio parameter selected to reduce the video or audio quality of the target video stream is a color depth parameter or a resolution parameter of the target video stream. Hence, the processing unit 320 may include a color depth determining module 326 and a resolution determining module 327. The color depth determining module 326 determines if the color depth parameter of the target video stream has been reduced to a minimum color depth value. The resolution determining module 327 determines if the resolution parameter of the target video stream has been reduced to a minimum resolution value. In one embodiment of this invention, the quality adjusting module 325 may reduce the color depth parameter of the target video stream gradually. When the color depth parameter of the target video stream is reduced to the minimum color depth value, the quality adjusting module 325 may then reduce the resolution parameter of the target video stream gradually. In another embodiment of this invention, the quality adjusting module 325 may reduce the resolution parameter of the target video stream gradually. When the resolution parameter of the target video stream is reduced to the minimum resolution value, the quality adjusting module 325 may then reduce the color depth parameter of the target video stream gradually. When the color depth parameter of the target video stream has been reduced to the minimum color depth value and the resolution parameter of the target video stream has been reduced to the minimum resolution value, the quality adjusting module 325 converts the target video stream into a black-and-white video stream for being transmitted to the client 500. Therefore, the black-and-white video stream is transmitted only when the color depth parameter and the resolution parameter are both set to minimum values. In other words, the target video stream may not be converted to the black-and-white video stream which is considered as poor quality, when there are still other video or audio parameters available for adjustment.

In another embodiment of this invention, the at least one video or audio parameter of the target video stream is a chrominance value or a chroma value of the target video stream, and the target video stream includes at least one reference frame and at least one inter frame which is predicted in accordance with the reference frame. Hence, the quality adjusting module 325 may set the reference frame and the at least one inter frame to the same chrominance value or the same chroma value so as to reduce the at least one video or audio parameter of the target video stream for reducing the video and audio quality of the target video stream.

In another embodiment of this invention, the at least one video or audio parameter of the target video stream includes an audio sampling rate of the target video stream. Hence, the quality adjusting module 325 may reduce the audio sampling rate of the target video stream to reduce the video or audio quality of the target video stream. For example, the quality adjusting module 325 may perform such reduction by reducing audio frequency or bit rate.

Furthermore, when the connection bandwidth of the client 500 is consistently sufficient for a period of time, the processing unit 320 may select at least one video or audio parameter of the target video stream according to the information about the connection bandwidth of the client to enhance the video or audio quality of the target video stream for being transmitted to the client 500. Therefore, when the connection bandwidth is sufficient, the target video stream can be provided with better quality to give users of the client 500 better watching experience.

The present invention can achieve many advantages. When the connection bandwidth of the client is insufficient, the bandwidth for the target video stream can be reduced by reducing the video or audio quality of the target video stream, thus preventing the target video stream from being played unsmoothly when the bandwidth is insufficient.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for adjusting video or audio quality of a video stream, the method comprising:
(a) receiving a video stream request for requesting an original target video stream from a client;
(b) obtaining information about a connection bandwidth of the client;
(c) determining if the connection bandwidth of the client is sufficient for receiving the target video stream; when it is determined that the connection bandwidth of the client is sufficient, directly transmitting the bandwidth-fitting target video stream, or enhancing the target video stream of which the quality has been reduced to obtain a quality-enhanced target video stream ; and then transmitting the quality-enhanced target video stream;
(d) when it is determined that the connection bandwidth of the client is insufficient, selecting at least one video or audio parameter according to the information about the connection bandwidth of the client to adjust and reduce the video or audio quality of the target video stream to obtain a quality-reduced target video stream, and transmitting the quality-reduced target video stream to the client; and
(e) repetitively performing step (b), step (c) and step (d) to transmit the whole target video stream to the client.

2. The method of claim 1, wherein a number of the at least one video or audio parameter is more than one.

3. The method of claim 2, wherein the video or audio parameters comprise a color depth parameter and a resolution parameter, and the method further comprises:
determining if the color depth parameter of the target video stream has been reduced to a minimum color depth value;
determining if the resolution parameter of the target video stream has been reduced to a minimum resolution value; and
when the color depth parameter of the target video stream has been reduced to the minimum color depth value and the resolution parameter of the target video stream has been reduced to the minimum resolution value, converting the target video stream into a black-and-white video stream for transmitting to the client.

4. The method of claim 2, further comprising:
receiving an adjusted video stream and setting a next video or audio adjustment parameter through a user interface according to the quality of the adjusted video stream.

5. The method of claim 2, further comprising
pre-setting a quality reduced selecting priority sequence of the video or audio parameters through a user interface.

6. The method of claim 1, wherein the at least one video or audio parameter of the target video stream is a chrominance value or a chroma value of the target video stream, and the target video stream comprises at least one reference frame and at least one inter frame which is predicted in accordance with the reference frame, and step (d) comprises:
setting the reference frame and the at least one inter frame with the same chrominance value or the same chroma value.

7. The method of claim 1, further comprising:
when the connection bandwidth of the client is continually sufficient, enhancing the at least one video or audio parameter of the target video stream.

8. The method of claim 1, further comprising:
temporarily storing the quality-reduced target video stream.

9. The method of claim 1, wherein the at least one video or audio parameter of the target video stream comprises an audio sampling rate of the target video stream, and step (d) comprises:
reducing the audio sampling rate of the target video stream.

10. A system for adjusting video or audio quality of a video stream, comprising:
a communication module for building a connection with a client; and
a processing unit electrically connected to the communication module, wherein the processing unit comprises:
a request receiving module for receiving a video stream request for requesting a target video stream from a client through the communication module;
a stream obtaining module for obtaining the target video stream;
a bandwidth information obtaining module for obtaining information about a connection bandwidth of the client;
a bandwidth determining module for determining if the connection bandwidth of the client is sufficient for receiving the target video stream; and
a quality adjusting module for selecting at least one video or audio parameter according to the information about the connection bandwidth of the client to adjust and reduce the video or audio quality of the target video stream to obtain a quality-reduced target video stream when it is determined that the connection bandwidth of the client is insufficient, and transmitting the quality-reduced target video stream to the client through the communication module.

11. The system for adjusting video or audio quality of a video stream of claim 10, wherein the at least one video or audio parameter of the target video stream comprises a color depth parameter and a resolution parameter of the target video stream, and the processing unit further comprises:
a color depth determining module for determining if the color depth parameter of the target video stream has been reduced to a minimum color depth value; and
a resolution determining module for determining if the resolution parameter of the target video stream has been reduced to a minimum resolution value;
wherein when the color depth parameter of the target video stream has been reduced to the minimum color depth value and the resolution parameter of the target video stream has been reduced to the minimum resolution value, the quality adjusting module converts the target video stream into a black-and-white video stream for being transmitted to the client.

12. The system of claim 10, wherein the at least one video or audio parameter of the target video stream is a chrominance value or a chroma value of the target video stream, and the target video stream comprises at least one reference frame and at least one inter frame which is predicted in accordance with the reference frame, and the quality adjusting module sets the reference frame and the at least one inter frame to the same chrominance value or the same chroma value so as to lower the at least one video or audio parameter of the target video stream.

13. The system of claim 10, further comprising:
a storage unit electrically connected to the processing unit, wherein the processing unit further comprises:
a temporarily storing module for temporarily storing the quality-reduced target video stream.
